(19) United States
(12) Patent Application Publication
(10) Pub. No.: US 2005/0060530 A1
(43) Pub. Date: Mar. 17, 2005

(54) Method for displaying information of updating BIOS

(75) Inventor: Chih-Hao Lin, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Giga-Byte Technology Co., Ltd, Shindian City (TW)

(21) Appl. No.: 10/661,949

(22) Filed: Sep. 12, 2003

(51) Int. Cl. G06F 9/00

(52) U.S. Cl. 713/2

(57) ABSTRACT

The purpose of the present invention is to provide a method for displaying an information of updating a basic input output system (BIOS) of a computer system, wherein the computer system having a specific configuration is initialized by a computer program stored in a basic input output system (BIOS) memory. The method includes steps of (a) interrupting the computer program in response to a first triggered signal, (b) loading an indexing data, (c) obtaining at least a file information of a basic input output system (BIOS) file and at least a directory information of a directory via an algorithm operation mathematical calculus according to the indexing data, (d) displaying the at least a file information and the at least a directory information, (e) selecting a demanded basic input output system (BIOS) file from the at least a file information and the at least a directory information, and (f) reprogramming the demanded basic input output system (BIOS) file into the basic input output system (BIOS) memory by means of executing a burn-in program.

### FIELD OF THE INVENTION

The present invention is related to a method for updating a basic input output system in a computer, and more particularly to a method for displaying an information of updating a basic input output system (BIOS) of a computer.

### BACKGROUND OF THE INVENTION

In a computer, a basic input output system (BIOS) is the essential software for handling details of computer input and output data. The basic input output system (BIOS) consists of a string of low-level codes. When a computer is powered on, or booted, the basic input output system (BIOS) initialization code is used by the computer to test its hardware and connectivity and to load all of the necessary operating code that allows the computer to perform needed tasks. The BIOS initialization code, which is stored in memory (e.g. lash memory and/or any device that stores digital information and can store the BIOS initialization code), includes a power-on self test (POST) procedure, to ensure that all computer circuitry is functional before running the operating code. The BIOS initialization code may be accessed by a processor (e.g. central processing unit (CPU), digital signal processor (DSP), microprocessor, microcontroller, microcomputer and/or any device that manipulates digital information based on programming instructions) when the computer is booted. The BIOS, in addition to other functions that are loaded (e.g. reading and writing data to various storage systems such as CD-ROM and DVD-ROM drives), allow the computer to perform its vast array of features. If a BIOS is determined to be corrupted, the computer may simply not boot.

However, several situations exist in which the BIOS may have to be updated. These situations include providing new BIOS features or functionality or providing fixes to certain BIOS problems. With the expanding the role of BIOS, it is necessarily becomes larger and more complex. Those skilled in the art will recognize that as BIOS has become more complex, it is now typically embodied in more advanced forms of nonvolatile memory that are capable of update. When computer system manufactures issue a new BIOS version including a burn-in program and an updating file, users can download the new BIOS version via the network. After users remotely download the updating file and store it in their computers, they can reprogram the BIOS updating file into the BIOS memory via the burn-in program for overwriting the older BIOS version or adding new features to the current BIOS version thereby finishing the BIOS updating procedure.

However, users have to remember the name of the BIOS file for executing the updating procedure via a burn-in program. The updating procedure is always executed after the users input the name of the BIOS file. If the users forget the name of the BIOS file, they have to terminate the burning program, enter the operating system (OS) to check that file name, and then execute the BIOS updating procedure again. It is not convenience and the users will spend a lot of time for checking the file name.

Accordingly, there should be a method of updating the BIOS provided for solving the above problems and updating the BIOS easily.

Therefore, it is tried to rectify those drawbacks and provide method for displaying information of updating a BIOS of a computer system by the present applicant.

### SUMMARY OF THE INVENTION

It is therefore a primary objective of the present invention to provide a method for displaying information of updating a BIOS of a computer system thereby facilitating a user to select a determined BIOS file form at least a file information and at least a directory information easily. Thus, the BIOS can be updated fast and conveniently. Furthermore, any unused BIOS file of the storage device can be deleted for saving the storage space.

It is another objective of the present invention to provide a method for displaying an information of updating a basic input output system (BIOS) of a computer system, wherein the computer system having a specific configuration is initialized by a computer program stored in a basic input output system (BIOS) memory, including (a) interrupting the computer program in response to a first triggered signal, (b) loading an indexing data, (c) obtaining at least a file information of a basic input output system (BIOS) file and at least a directory information of a directory via an algorithm operation mathematical calculus according to the indexing data, (d) displaying the at least a file information and the at least a directory information, (e) selecting a demanded basic input output system (BIOS) file from the at least a file information and the at least a directory information, and (f) reprogramming the demanded basic input output system (BIOS) file into the basic input output system (BIOS) memory by means of executing a burn-in program.

Certainly, the basic input output system (BIOS) memory can be an electrically erasable programmable nonvolatile memory (EEPROM).

Certainly, the electrically erasable programmable nonvolatile memory (EEPROM) can be a flash memory.

Certainly, the first triggered signal can be produced by means of pushing a hot key.

Certainly, the hot key can be disposed on a basic input output unit.

Certainly, the basic input output unit can be a keyboard.

Certainly, the indexing data can be stored in a storage device.

Certainly, the indexing data can be one selected from a group consisting of a file allocation table (FAT), a root directory, a file description block and a relative index of a medium.

Certainly, the storage device can be one selected from a group consisting of a floppy disk (FD), a hard disk (HD), a compact disk (CD), a ZIP disk, an LS-120 disk and a tape.

Certainly, the algorithm operation can be a relative operation of the storage device.

Certainly, the burn-in program can be stored in a storage device.

Preferably, the step (d) further includes steps of (d1) deleting an unused file of the storage device and storing another basic input output system file to the storage device in response to a second triggered signal, and (d2) redisplaying the at least a file information and the at least a directory information.

Preferably, the method further includes a step of (g) rebooting the computer system and executing the reprogrammed computer program for initializing the computer system.

Preferably, the file information includes a file name, a file size and a stored date of the basic input output system (BIOS) file.

Certainly, the first triggered signal can be a data defined by the computer program stored in the basic input output system (BIOS) memory.

According to the present invention, the method for updating a basic input output system (BIOS) of a computer system having a specific configuration and being initialized by a computer program stored in a basic input output system (BIOS) memory, includes (a) interrupting the computer program in response to a first triggered signal, (b) loading an indexing data, (c) obtaining at least a file information of a basic input output system (BIOS) file and at least a directory information of a directory via an algorithm operation according to the indexing data, (d) displaying the at least a file information and the at least a directory information, (e) deleting an unused file of the storage device and storing another basic input output system file to the storage device in response to a second triggered signal, (f) redisplaying the at least a file information and the at least a directory information, (g) selecting a demanded basic input output system (BIOS) file from the at least a file information and the at least a directory information, and (h) reprogramming the demanded basic input output system (BIOS) file into the basic input output system (BIOS) memory by means of executing a burn-in program.

Certainly, the second triggered signal can be produced by means of pushing a hot key.

Certainly, the hot key can be disposed on a basic input output unit.

Certainly, the basic input output unit can be a keyboard.

Certainly, the indexing data can be stored in a storage device.

Certainly, the indexing data can be one selected from a group consisting of a file allocation table (FAT), a root directory, a file description block and a relative index of a medium.

Certainly, the storage device can be one selected from a group consisting of a floppy disk (FD), a hard disk (HD), a compact disk (CD), a ZIP disk, an LS-120 disk and a tape.

Certainly, the algorithm operation can be a relative operation of the storage device.

Certainly, the burn-in program can be stored in a storage device.

Preferably, the method further includes a step of (i) rebooting the computer system and executing the reprogrammed computer program for initializing the computer system.

Certainly, the burn-in program can be executed in response to a third triggered signal.

Preferably, the file information includes a file name, a file size and a stored date of the basic input output system (BIOS) file.

Certainly, the first triggered signal can be a data defined by the computer program stored in the basic input output system (BIOS) memory.

Preferably, the directory information includes a directory name and a created date thereof.

The foregoing and other features and advantages of the present invention will be more clearly understood through the following descriptions with reference to the drawings, wherein:

### BRIEF DESCRIPTION OF THE DRAWING

FIG. 1 illustrates a functional diagram of a computer system for displaying an information of updating a basic input output system (BIOS) thereof;

FIG. 2 illustrates a flow chart of a first embodiment according to the present invention; and

FIG. 3 illustrates a flow chart of a second embodiment according to the present invention.

### DETAILED DESCRIPTION OF THE PREFERRED EMBODIMENTS

The primary objective of the present invention is to provide a method for displaying information of updating a BIOS of a computer system thereby facilitating a user to select a determined BIOS file form at least a file information and at least a directory information easily. Thus, the BIOS can be updated fast and conveniently. Furthermore, any unused BIOS file of the storage device can be deleted for saving the storage space.

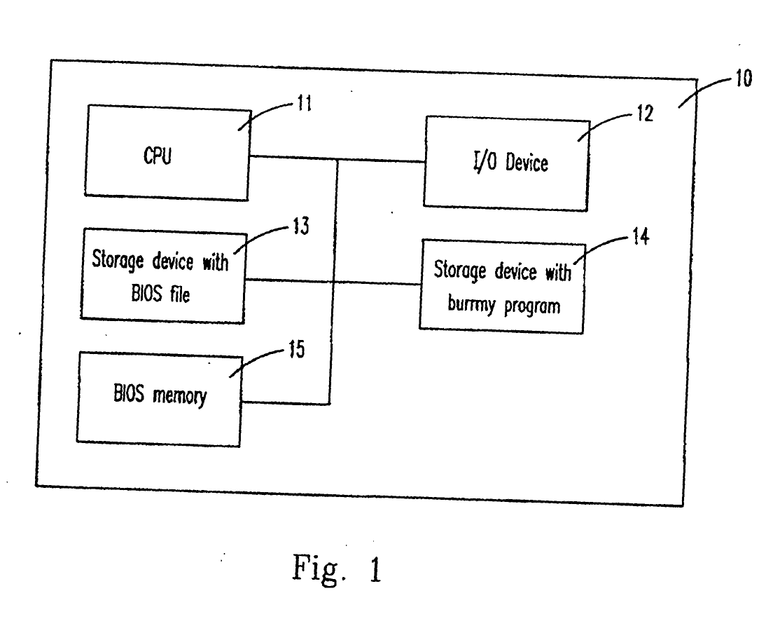

Please refer to FIG. 1. It illustrates a functional diagram of a computer system for displaying an information of updating a basic input output system (BIOS) thereof. When a computer system 10 is powered on, the basic input output system (BIOS) initialization code stored in a BIOS memory 15 is used by the computer to test its hardware and connectivity and to load all of the necessary operating code that allows the computer 10 to perform needed tasks. The BIOS initialization code, which is stored in the BIOS memory 15, includes plural hot keys of different commands.

When a user powers on the computer system 10 and executes the BIOS program, a button of an input device 12 (ex. a keyboard) is pushed and a scan code of the button is transmitted to the CPU 11 for being processed. Meanwhile the BIOS program will capture the scan code of the pushed button and process it.

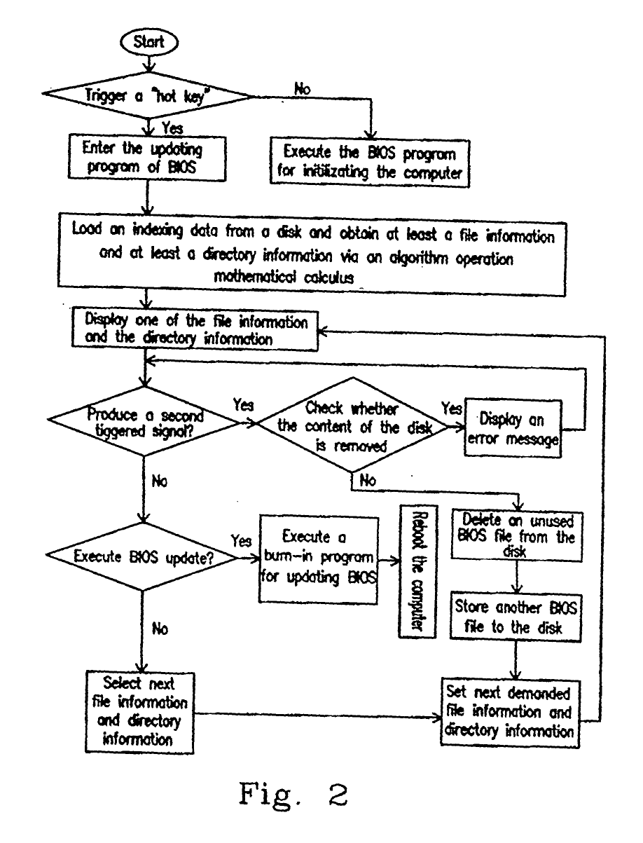

Please refer to FIG. 2. It illustrates a flow chart of a first embodiment according to the present invention. When the scan code of the working button pushed by a user is corresponding with the scan code of the hot key defined by the BIOS program for updating BIOS, the BIOS program is interrupted in response to a first triggered signal produced by means of pushing the button, and then the BIOS updating program is loaded and executed. Meanwhile the BIOS updating program loads an indexing data and obtains at least a file information of a basic input output system (BIOS) file stored in the storage device 13 and at least a directory information of a directory via an algorithm operation mathematical calculus according to the indexing data, wherein the indexing data is one selected from a group consisting of a file allocation table (FAT), a root directory, a file description block and a relative index of a medium. Then one of the file information and the directory information is displayed. Meanwhile the file information includes a file name, a file size and a stored date of the basic input output system (BIOS) file and the directory information includes a directory name and a created date thereof.

When the user pushes other button, which has a scan code corresponding with the scan code of the hot key defined by the BIOS program for deleting an unused file of the storage device and storing another basic input output system file to the storage device, the BIOS program checks whether the content of the storage device is changed or the storage device is removed in response to a second triggered signal of the pushed button. If the content of the storage device is changed or the storage device is removed, an error message is displayed to inform the user. If the storage device is corresponding with the demand, an unused file of the storage device is deleted and another basic input output system file is stored to the storage device.

Furthermore, one of the file information and the directory information is redisplayed and provided for the user to select. When a demanded basic input output system (BIOS) file is selected from the file information and the directory information, a burn-in program stored in a storage device 14 is loaded in response to a third triggered signal for reprogramming the demanded basic input output system (BIOS) file into the basic input output system (BIOS) memory 15 by means of executing the burn-in program. Finally, the computer system is rebooted for executing the reprogrammed computer program to initialize the computer system.

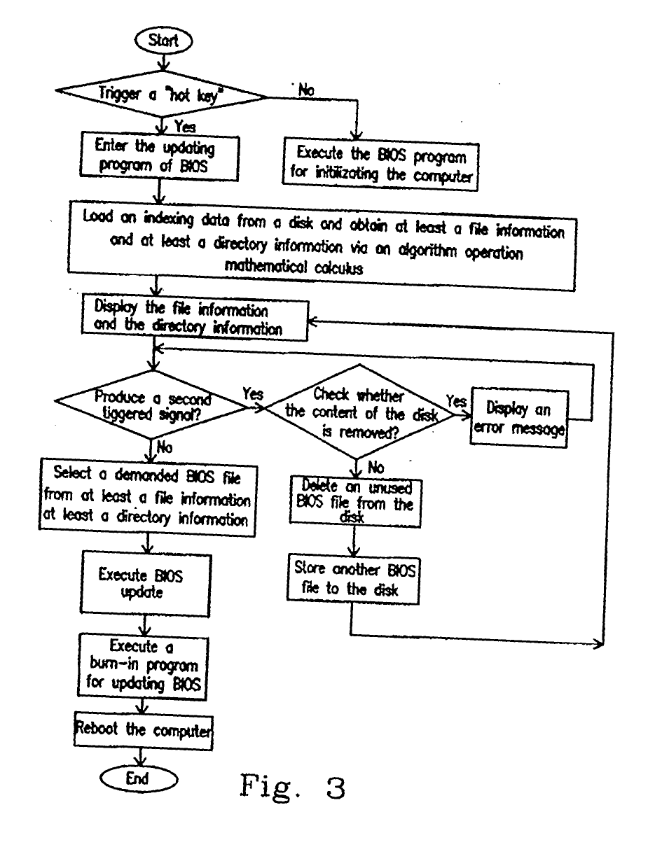

Please refer to FIG. 3. It illustrates a flow chart of a second embodiment according to the present invention. Compared with that of the first embodiment, the displaying device of this embodiment displays the obtained file information and directory information at a time. A user could select a demanded basic input output system (BIOS) file by means of controlling the arrow keys.

Meanwhile the basic input output system (BIOS) memory is an electrically erasable programmable nonvolatile memory (EEPROM) and the storage device could be one selected from a group consisting of a floppy disk (FD), a hard disk (HD), a compact disk (CD), a ZIP disk, an LS-120 disk and a tape.

Accordingly, the invention is related to a method for displaying information of updating a BIOS of a computer system thereby facilitating a user to select a determined BIOS file form at least a file information and at least a directory information easily. Thus, the BIOS can be updated fast and conveniently. The user doesn't have to terminate the burning program, enter the operating system (OS) to check that file name. It is believed that the present invention is practicable for the industry.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

1. A method for displaying an information of updating a basic input output system (BIOS) of a computer system, wherein said computer system having a specific configuration is initialized by a computer program stored in a basic input output system (BIOS) memory, comprising:
(a) interrupting said computer program in response to a first triggered signal;
(b) loading an indexing data;
(c) obtaining at least a file information of a basic input output system (BIOS) file and at least a directory information of a directory via an algorithm operation mathematical calculus according to said indexing data;
(d) displaying said at least a file information and said at least a directory information;
(e) selecting a demanded basic input output system (BIOS) file from said at least a file information and said at least a directory information; and
(f) reprogramming said demanded basic input output system (BIOS) file into said basic input output system (BIOS) memory by means of executing a burn-in program.

2. The method according to claim 1, wherein said basic input output system (BIOS) memory is an electrically erasable programmable nonvolatile memory (EEPROM).

3. The method according to claim 1, wherein said electrically erasable programmable nonvolatile memory (EEPROM) is a flash memory.

4. The method according to claim 1, wherein said first triggered signal is produced by means of pushing a hot key.

5. The method according to claim 1, wherein said hot key is disposed on a basic input output unit.

6. The method according to claim 1, wherein said basic input output unit is a keyboard.

7. The method according to claim 1, wherein said indexing data is stored in a storage device.

8. The method according to claim 7, wherein said indexing data is one selected from a group consisting of a file allocation table (FAT), a root directory, a file description block and a relative index of a medium.

9. The method according to claim 7, wherein said storage device is one selected from a group consisting of a floppy disk (FD), a hard disk (HD), a compact disk (CD), a ZIP disk, an LS-120 disk and a tape.

10. The method according to claim 7, wherein said algorithm operation is a relative operation of said storage device.

11. The method according to claim 1, wherein said burn-in program is stored in a storage device.

12. The method according to claim 1, wherein said step (d) further comprises steps of:
(d1) deleting an unused file of said storage device and storing another basic input output system file to said storage device in response to a second triggered signal; and
(d2) redisplaying said at least a file information and said at least a directory information.

13. The method according to claim 1 further comprising a step of:
(g) rebooting said computer system and executing said reprogrammed computer program for initializing said computer system.

14. The method according to claim 1, wherein said file information includes a file name, a file size and a stored date of said basic input output system (BIOS) file.

15. The method according to claim 1, wherein said first triggered signal is a data defined by said computer program stored in said basic input output system (BIOS) memory.

16. A method for updating a basic input output system (BIOS) of a computer system having a specific configuration and being initialized by a computer program stored in a basic input output system (BIOS) memory, comprising:
(a) interrupting said computer program in response to a first triggered signal;
(b) loading an indexing data;
(c) obtaining at least a file information of a basic input output system (BIOS) file and at least a directory information of a directory via an algorithm operation according to said indexing data;
(d) displaying said at least a file information and said at least a directory information;
(e) deleting an unused file of said storage device and storing another basic input output system file to said storage device in response to a second triggered signal;
(f) redisplaying said at least a file information and said at least a directory information;
(g) selecting a demanded basic input output system (BIOS) file from said at least a file information and said at least a directory information; and
(h) reprogramming said demanded basic input output system (BIOS) file into said basic input output system (BIOS) memory by means of executing a burn-in program.

17. The method according to claim 16, wherein said second triggered signal is produced by means of pushing a hot key.

18. The method according to claim 17, wherein said hot key is disposed on a basic input output unit.

19. The method according to claim 18, wherein said basic input output unit is a keyboard.

20. The method according to claim 16, wherein said indexing data is stored in a storage device.

21. The method according to claim 20, wherein said indexing data is one selected from a group consisting of a file allocation table (FAT), a root directory, a file description block and a relative index of a medium.

22. The method according to claim 20, wherein said storage device is one selected from a group consisting of a floppy disk (FD), a hard disk (HD), a compact disk (CD), a ZIP disk, an LS-120 disk and a tape.

23. The method according to claim 20, wherein said algorithm operation is a relative operation of said storage device.

24. The method according to claim 16, wherein said burn-in program is stored in a storage device.

25. The method according to claim 1 further comprising a step of:
(i) rebooting said computer system and executing said reprogrammed computer program for initializing said computer system.

26. The method according to claim 16, wherein said burn-in program is executed in response to a third triggered signal.

27. The method according to claim 16, wherein said file information includes a file name, a file size and a stored date of said basic input output system (BIOS) file.

28. The method according to claim 16, wherein said first triggered signal is a data defined by said computer program stored in said basic input output system (BIOS) memory.

29. The method according to claim 16, wherein said directory information includes a directory name and a created date thereof.
